(19) United States
(12) Patent Application Publication
(10) Pub. No.: US 2013/0022204 A1
(43) Pub. Date: Jan. 24, 2013

(54) LOCATION DETECTION USING SURROUND SOUND SETUP

(71) Applicants: Suranjit Adhikari, San Diego, CA (US); Eric Hsiao, San Diego, CA (US)

(72) Inventors: Suranjit Adhikari, San Diego, CA (US); Eric Hsiao, San Diego, CA (US)

(73) Assignee: Sony Corporation, Tokyo (JP)

(21) Appl. No.: 13/187,923

(22) Filed: Jul. 21, 2011

(51) Int. Cl. H04R 5/00

(52) U.S. Cl. 381/17

(57) ABSTRACT

Methods and device are provided for calibrating one or more components of a home theater system. In one embodiment a method includes detecting a command to calibrate a home theater system, providing a prompt based on the command to request a voiced response, and receiving a sound signal associated with a user in response to the prompt, the sound signal detected by at least one speaker of the home theater system. The method may further include determining a position of the user based on the sound signal, and calibrating at least one component of the home theater system based on the position.

### FIELD

The present disclosure relates generally to electronic devices for providing a multi-channel media environment, and more particularly to methods and apparatus for calibrating one or more components of a home theater system.

### BACKGROUND

Many television owners use home theater components to enrich viewing of media content. A typical home theater system does not allow for calibration of output devices relative to an area in which the system is used or the position of a user relative to the output devices. Rather, the conventional home theater system is adjust based on the volume control knob. There is, however a desire to calibrate output devices of a home theater system. Some conventional attempts of calibrating output devices require either manual adjustment of signals to each output device. These methods are tedious, and may be difficult for many users to calibrate effectively. One common issue to many users may be differing distances between output devices of a home theater system and the position of a user during operation of a home theater system. These distances may either overemphasis, or under emphasize output of one or more output devices. As such, home theater experiences may be diluted by when a home theater system is not calibrated properly. Accordingly, there is a desire for functionality by control devices and display devices that overcome one or more of the aforementioned drawbacks and provide useful technological solutions and functionality that may improve the experience of home theater systems.

### BRIEF SUMMARY OF THE EMBODIMENTS

Disclosed and claimed herein are methods and apparatus for calibrating one or more components of a home theater system. In one embodiment, a method includes detecting a command to calibrate a home theater system, providing a prompt based on the command to request a voiced response, and receiving a sound signal associated with a user in response to the prompt, the sound signal detected by at least one speaker of the home theater system. The method further includes determining a position of the user based on the sound signal, and calibrating at least one component of the home theater system based on the position.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of home theater system according to one or more embodiments;

FIG. 2 depicts a process for calibrating one or more components of a home theater system according to one or more embodiments;

FIG. 3 depicts a simplified block diagram of a device according to one or more embodiments;

FIG. 4 depicts a simplified block diagram of a home theater system according to one or more embodiments; and

FIG. 5 depicts a graphical representation of calibrating a component of a home theater system according to one or more embodiments.

### DETAILED DESCRIPTION OF THE EXEMPLARY EMBODIMENTS

### Overview and Terminology

One aspect of the disclosure relates to calibrating one or more components of a home theater system based on a position of a user. Output devices, or speakers of a home theater system, may be configured to output sounds signals to a control device for detection a position of a user. Methods and apparatus are provided for calibrating a home theater system during setup and dynamic calibration of one or more components. One advantage of the embodiments described herein, may be the ability to detect user generated sound signals using speakers components of the home theater system. Based on a determined position, output attributes of audio and/or video data may be modified to direct output to a detected position.

In one embodiment, a method is provided for calibrating one or more components of a home theater system. In another embodiment, a device is provided which may be configured to detect one or more user generated sound signals via speakers of a home theater system. The device may relate to one or more of a set-top box, display device, receiver, media player, gaming console, computing device, or electronic device in general.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, non-transitory medium, etc.

### Exemplary Embodiments

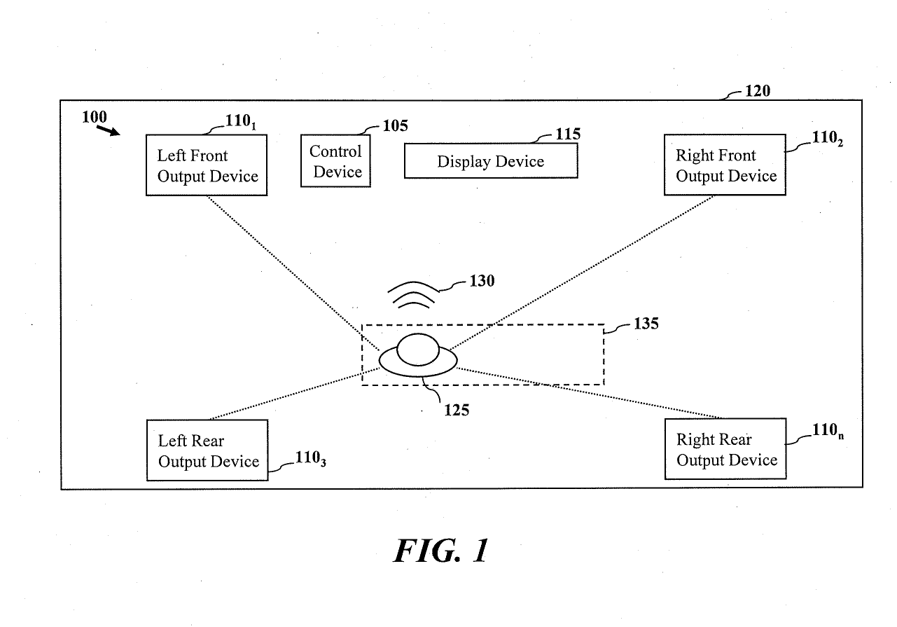

Referring now to the figures, FIG. 1 depicts a graphical representation of home theater system 100 which may be employed by one or more embodiments described herein. System 100 includes control device 105, a plurality of output devices 110₁₋ₙ, and display device 115. System 100 may be configured to output audio data, video data, data in general and/or commands to one or more components. As will be described below in more detail, control device 105 may be coupled to and communicate with output devices 110₁₋ₙ, and display device 115. In one embodiment, control device 105 may be configured to process audio and/or video data received from an external device, data processed from memory, and media read by the control device. Control device 105 may be configured to control output among various components to provide a rich and entertaining experience for users. For example, audio output by control device 105 may be split relative to output devices 110₁₋ₙ. Control device 105 may relate to one or more of a set-top box, display device, receiver, media player, gaming console, computing device, or electronic device in general. Although depicted as separate elements, control device 105 may be included within display device 115. In other embodiments, display device 115 may be optional.

Output devices 110₁₋ₙ may relate to speakers of home theater system 100. Each output device in system 100 may include one or more speakers (e.g., drivers) for output of audio data. Output devices 110₁₋ₙ are positioned in area 120 labeled as left front, right front, left rear, and right rear relative to the perspective of a user, such as user 125. Output devices 110₁₋ₙ may be positioned in area 120 to present sound to a user and provide a surround sound or multi-channel presentation of media. Although the configuration of output devices 110₁₋ₙ is depicted as four output devices, it should be appreciated that other configurations may be employed to include additional output devices such as a center channel, low-frequency driver (e.g., subwoofer), etc.

According to one embodiment, output devices 110₁₋ₙ may output received audio or sound data for control device 105. A typical speaker operates by transducing an electric signal into an acoustic or sound signal. Speakers may also transduce acoustic or sound signals to electrical signals. However, conventional home theater systems only operate speakers for output of sound. The control devices of conventional home theater systems do not transduce acoustic energy due to circuit design. One embodiment is directed to configuring control device 100 to output a sound signal to output device 110₁₋ₙ and receive sound signals from one or more output devices. As will be described in more detail below with respect to FIG. 3, control device 105 may be configured to control operation of output devices 110₁₋ₙ to receive acoustic or sound signals.

According to another embodiment, system 100 may be calibrate on or more components. By way of example, control device 105 may be configured to calibrate one or more components of system 100 including calibrating sound levels of output devices 110₁₋ₙ, adjusting viewing angle of display device 115, adjusting orientation of output devices 110₁₋ₙ, etc. In one embodiment, calibration by control device 105 may be based on position of a user. By generating a location, or approximate position, of a user, components of system 100 may be calibrated to optimize or enhance presentation of output to a user. Many conventional theater systems do not allow for adjusting or calibrating output sound levels of output devices. Similarly, these systems do not allow for detection position of a user. Output devices 110₁₋ₙ may be configured to receive sound, such as a voice response, vocal output, or sound in general, generated by a user. As depicted in FIG. 1, sound 130 generated by user 125 may be detected by output devices 110₁₋ₙ. The sound signals received by each output device may be detected and processed by control device 105 to determine the position of user 125. In certain embodiments, control device 105 may calibrate components of system 100 based on a calculated position of user 125. In other embodiments, control device 105 may calibrate components of system 100 based on area 135 associated with a calculated position of user 125.

Although system 100 of FIG. 1 is described above as relating to a home or residential system, it should be equally appreciated that system 100 and the embodiments of the disclosure described herein are not limited to home theater systems, but may be applied to commercial theaters, office systems, and theaters in general.

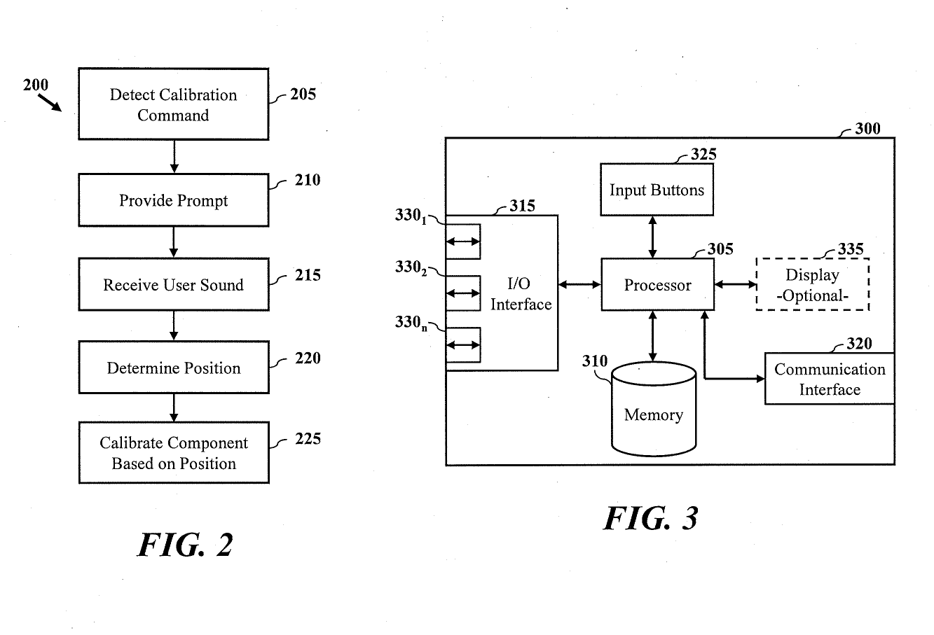

Referring now to FIG. 2, a process is depicted for calibrating one or more components of a home theater system according to one or more embodiments. Process 200 may be employed by a control device (e.g., control device 105) to calibrate one or more components of a home theater system (e.g., home theater system 100). Process 200 may be initiated by detecting a calibration command at block 205. The calibration command may relate to a command for initial set-up of a home theater system. Alternatively, the calibration command may be detected for calibrating a home theater system biased on a particular media or position of a user. In one embodiment, the calibration command detected at block 205 may be based on one or more of user input to a control device and a remote control command received by the control device. The command may relate to a menu selection of a user interface generated by the control device and displayed for user operation. Alternatively, the command may be generated automatically by a control unit to calibrate a home theater system. For example, the control unit may detect an initial startup, the addition of an output device, or modification to the arrangement of output devices and initiate calibration.

Process 200 may proceed with providing a prompt to request a user generated sound at block 210. The prompt may be one or more of a visual display, sound output to output devices, recorder voice or displayed message by a display device. When a display device, such as a TV, is coupled to or is the control device, a message may be displayed to a user in order to request that the user voice or generate a sound for detection by one or more output devices. The generated sound may be detected by the one or more output devices and utilized to estimate a position of the user. In one embodiment, calibration may be based on the user speaking or singing one or more terms or pitches for a predetermined period of time. The control device may analyze each of the signals received by the output devices to determine a distance from each output device. In certain embodiments, the prompt may requires a user generated sound for a predetermined period of time. The prompt may be adjusted to guide a user in modifying the user generated sound by requesting a louder or prolonged sound to be generated. In certain embodiments, the prompt may be output by the output devices as a tone or recorded phrase requesting the user to generate a sound. In certain embodiments, the control device may interoperate with a device configured to output a particular sound that may be recognized. For example, the user may employ a personal communication device or portable media player to output a particular tone, sequence of tones, or sound byte which may be detected by the speakers of the home theater system.

At block 215, the control device receives one or more sound signals associated with the user generated sound. The one or more received sound signals may be received from a plurality of speakers or output devices. Process 200 may include setting the output devices to received sound for a period of time following the prompt in order to detect sound.

At block 220, the control device may determine a position of the user based on the sound signal. Position of a user may be determined based on the time delay of the sound signal relative to each output device. The position may be determined based on differences between received channels and the time period of a prompt. The position may be a local approximation. In certain embodiments the position may be a general area associated with the position of the user.

Process 200 may continue with calibration of at least one component of the home theater system based on the position at block 225. In one embodiment, calibrating the at least one component includes setting an output level and/or delay for each speaker. Signals output to each speaker may be tailored based on the position determined at block 215. In certain embodiments, speakers may be calibrated in groups, wherein front right and left speakers may be adjusted to have the same output level. In another embodiment, signals for each speaker may be determined based on the position. Calibrating may also relate to adjusting an angular orientation of one or more speakers. In certain embodiments, speakers may be mechanically adjusted by a control device and pointed toward the user. In a similar fashion, the angular orientation of a display device may be position based on the detected position. For example, the control device may control the swivel angle to improve the viewing angle for a user. Calibration may also be performed based on one or more characteristics of a room the home theater system is set up in, and for presentation based on a particular media type. For example, with respect to presentation of three-dimensional (e.g., 3-D) media, one or more characteristics of the display device may be calibrated based on the position of the user. Calibration of one or more components of the home theater system may be performed during an initial setup of the home theater system. In other embodiments, calibration of the home theater system may be performed to accommodate different numbers of viewers and/or based on the particular media type for output.

Process 200 may further include storing one or more calibration settings by the control device. Stored calibration settings may be recalled by the user for arranging components of the home heater system.

Referring now to FIG. 3, a simplified block diagram is depicted of a device according to one embodiment. Device 300 may relate to one or more of the control device of FIG. 1, a set-top box, display device, receiver, media player, gaming console, computing device, or electronic device in general. Device 300 may be configured to calibrate one or more output characteristics of output devices in a home theater system. In another embodiment, device 300 may be configured to adjust the orientation of one or more components of the home theater system. In certain embodiments, device 300 may relate to a peripheral device configured to interface with a display device, such as a set-top box, media player, etc.

As depicted in FIG. 3, device 300 includes processor 305, memory 310, input/output (I/O) interface 315, communication interface 320, and input buttons 325. Elements of device 300 may be configured to communicate and interoperate by a communication bus with processor 305. Processor 305 may be configured to control operation of device 300 based on one or more computer executable instructions stored in memory 310. In one embodiment, processor 305 may be configured to control output of audio and video data, and calibrate one or more components of a home theater system. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more audio and video files.

Input output (I/O) interface 315 may be configured to output data and/or commands to one or more output devices. In one embodiment, speakers of a home theater system may be coupled to I/O 315 for output of sound signals. Each speaker may be coupled to a particular port or connection of I/O 315, wherein I/O 315 includes a plurality of ports 330₁₋ₙ. According to one embodiment, I/O interface 315 may be configured to set one or more of ports 330₁₋ₙ to allow for speakers to receive sound signals. In one embodiment, each port of I/O interface 315 may be configured to switch between an output mode and input mode, the input mode allowing for a speaker to act as a microphone and provide sound signals to processor 305.

Communication interface 320 may include one or more elements to allow for communication by device 300 by wired or wireless communication. I/O interface 320 may include one or more ports for receiving data, including ports for removable memory. I/O interface 320 may be configured to allow for network based communications including but not limited to LAN, WAN, Wi-Fi, etc.

Input buttons 325 may be employed to control operation of device 300 including controlling selection of content for display and controlling operation of device 300. Input buttons 325 may include one or more buttons for user input, such as a such as a numerical keypad, volume control, menu controls, pointing device, track ball, mode selection buttons, and playback functionality (e.g., play, stop, pause, forward, reverse, slow motion, etc). Input buttons 325 may include hard and soft buttons, wherein functionality of the soft buttons may be based on one or more applications running on device 300.

In certain embodiments device 300 may relate to a display device and include optional display 335. Display 335 may be employed to display image data, such as video data, and display one or more applications executed by processor 305.

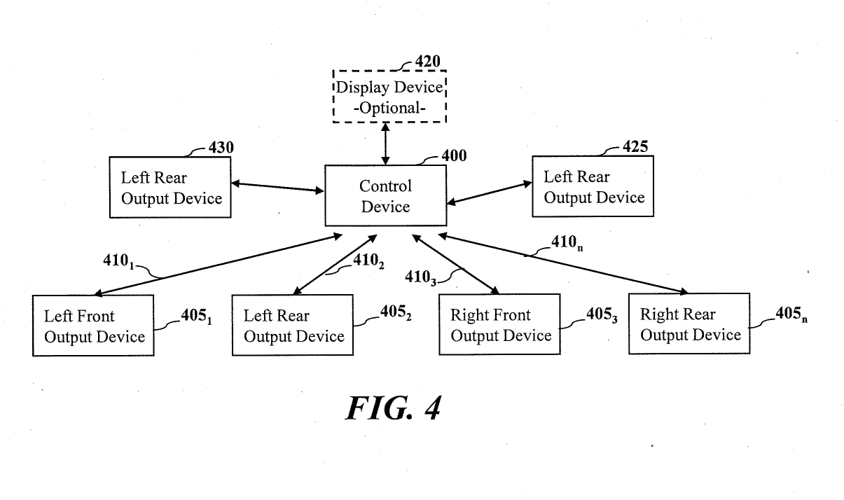

Referring now to FIG. 4, a simplified block diagram is depicted of a home theater system according to one or more embodiments. A home theater system may include control device 400 (e.g., control device 105). Control device 400 may output audio data to one or more output devices 405₁₋ₙ. Communications links 410₁₋ₙ may relate to wired or wireless communication paths between output devices 405₁₋ₙ and control device 400.

In certain embodiments, control device may be part of a display device. However, in certain embodiments, control device 400 may be part of a peripheral device, such as a receiver or set-top box. Accordingly, control device 400 may communicate with optional display device 420 for output or audio and video data.

Control device 400 may be configured to receive media, such as audio and video data from a media player 425. In certain embodiments, control device 400 may additionally receive one or more commands from a control device 430. Control device 430 may relate to a remote control, or in some embodiments may be a portable sound generating device. In some embodiments, a user generated sound may related to a sound generate by a sound generating device. The sound generating device may output a particular sound that may facilitate comparison of speaker output and may be configured to output a particular pitch at one or more intervals.

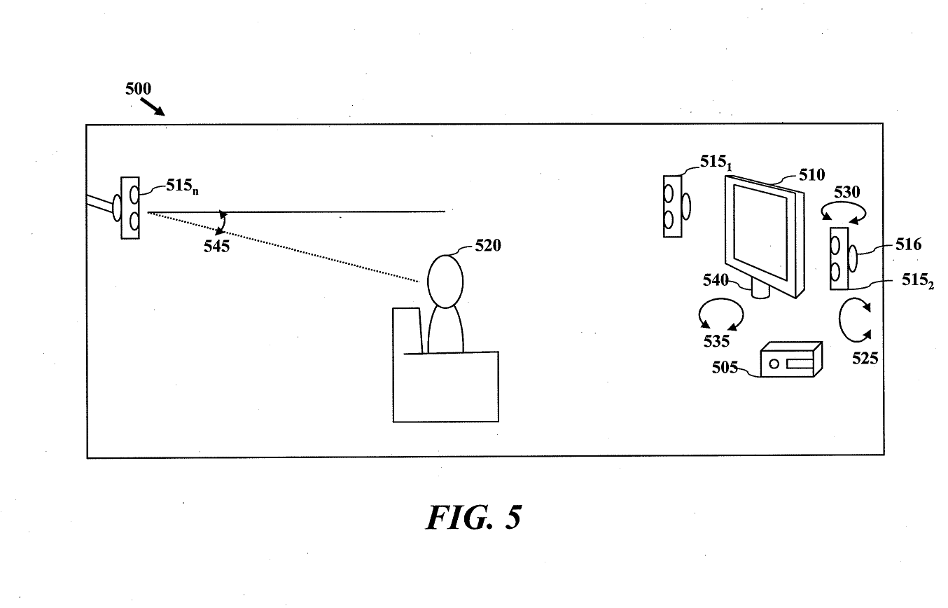

Referring now to FIG. 5, a graphical representation is depicted of calibrating a component of a home theater system according to one or more embodiments. A home theater system may be setup in room 500, the home theater system including control device 505 (e.g. control device 105), display device 510 and output device 515₁₋ₙ. According to one embodiment, control device 505 may calibrate one or more components of a home theater system based on the position of user 520. In one embodiment, control device 505 may adjust vertical orientation 525 and horizontal orientation 530 of output device 515₂ via adjustable mount 516. Output device 515₁₋ₙ may be adjusted based on a position detected of user 520 relative to one or more output devices. Adjustment of output devices 515₁₋ₙ may be based on motorized or powered control elements within each output device. Calibration signals may be provided via wired or wireless data paths for calibration orientation of output devices 515₁₋ₙ.

According to another embodiment, control device 505 may control the horizontal orientation 535 of display device 510 by control of powered swivel 540 of display device 505. The horizontal calibration of display device 510 may optimize viewing angle for a user. In certain embodiments, viewing angle of display device 510 may be determined by comparing delay of a user generated sound with respect to speakers on either side of display device 510.

In addition to calibrating a home theater system during an initial installation to customize a home theater system to a users particular arrangement of a room or viewing area, components of a home theater system may be calibrated based on a particular media type output by control device 505. Output device 515₁₋ₙ for examples is depicted in an orientation. In certain embodiments, control device may output a command to output device 515₁₋ₙ to have an angular offset depicted as 545 with respect to a previous orientation. In that fashion, output devices may be calibrated during operation of a home theater system.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for calibrating one or more components of a home theater system, the method comprising the acts of:
detecting a command to calibrate a home theater system;
providing, by a control device, a prompt based on the command to request a voiced response;
receiving, by the control device, a sound signal associated with a user in response to the prompt, the sound signal detected by at least one speaker of the home theater system;
determining a position of the user based on the sound signal; and
calibrating at least one component of the home theater system based on the position.

2. The method of claim 1, wherein the command is detected based on one or more of a user input to the control device and remote control command received by the control device.

3. The method of claim 1, wherein the command relates to one or more of a menu selection of a user interface provided by the control unit and a command to generated by the control unit for calibration of the home theater system.

4. The method of claim 1, wherein the prompt is one or more of a visual display, sound output, recorded voice and displayed message generated by the control device.

5. The method of claim 1, wherein receiving a sound signal relates to receiving a plurality of sounds signals form a plurality of speakers of the home theater system.

6. The method of claim 1, wherein the position is determined based on one or more of the time delay the sound signal relative to the a time period associated with the prompt.

7. The method of claim 1, wherein the position relates to one or more of a position of the user and a region associated with the position of the user.

8. The method of claim 1, wherein calibrating at least one component includes calibrating one or more of an output level and delay of a speaker.

9. The method of claim 1, wherein calibrating at least one component includes adjusting an angular orientation one or more speakers of the home theater system.

10. The method of claim 1, wherein calibrating at least one component includes calibrating the angular position of a display device.

11. The method of claim 1, wherein calibrating at least one component includes calibrating display for presentation of three-dimensional media.

12. The method of claim 1, further comprising detecting a media type for output by the control device, wherein calibrating the at least one component is further based on the media type.

13. The method of claim 1, further comprising storing a calibration setting of the control device.

14. A computer program product stored on computer readable medium including computer executable code for calibrating one or more components of a home theater system, the computer program product comprising:
computer readable code to detect a command to calibrate a home theater system;
computer readable code to providing a prompt based on the command to request a voiced response;
computer readable code to receive a sound signal associated with a user in response to the prompt, the sound signal detected by at least one speaker of the home theater system;
computer readable code to determine a position of the user based on the sound signal; and
computer readable code to calibrate at least one component of the home theater system based on the position.

15. The computer program product of claim 14, wherein the command is detected based on one or more of a user input to the control device and remote control command received by the control device.

16. The computer program product of claim 14, wherein the command relates to one or more of a menu selection of a user interface provided by the control unit and a command to generated by the control unit for calibration of the home theater system.

17. The computer program product of claim 14, wherein the prompt is one or more of a visual display, sound output, recorded voice and displayed message generated by the control device.

18. The computer program product of claim 14, wherein receiving a sound signal relates to receiving a plurality of sounds signals form a plurality of speakers of the home theater system.

19. The computer program product of claim 14, wherein the position is determined based on one or more of the time delay the sound signal relative to the a time period associated with the prompt.

20. The computer program product of claim 14, wherein the position relates to one or more of a position of the user and a region associated with the position of the user.

21. The computer program product of claim 14, wherein calibrating at least one component includes calibrating one or more of an output level and delay of a speaker.

22. The computer program product of claim 14, wherein calibrating at least one component includes adjusting an angular orientation one or more speakers of the home theater system.

23. The computer program product of claim 14, wherein calibrating at least one component includes calibrating the angular position of a display device.

24. The computer program product of claim 14, wherein calibrating at least one component includes calibrating display for presentation of three-dimensional media.

25. The computer program product of claim 14, further comprising computer readable code to detect a media type for output by the control device, wherein computer readable code to calibrate the at least one component is further based on the media type.

26. The computer program product of claim 14, further comprising computer readable code to store a calibration setting of the control device.

27. A control device comprising:
an interface to output and receive sound data to a plurality of speakers; and
a processor coupled to the interface, the processor configured to
detect a command to calibrate a home theater system;
provide a prompt based on the command to request a voiced response;
receive a sound signal associated with a user in response to the prompt, the sound signal detected by at least one speaker of the home theater system;
determine a position of the user based on the sound signal; and
calibrate at least one component of the home theater system based on the position.

28. The device of claim 27, wherein the device relates to one or more of a set-top box, display device, receiver, media player, gaming console, computing device, or electronic device in general.
